(19) United States
(12) Patent Application Publication
(10) Pub. No.: US 2026/0175603 A1
(43) Pub. Date: Jun. 25, 2026

(54) PRINTHEAD FOR A 3D PRINTER WITH A PRESSURE MEASURING SYSTEM

(71) Applicant: Robert Bosch GmbH, Stuttgart (DE)

(72) Inventors: Chris Nickels, Burgstetten-Erbstetten (DE); Hendrik Jahnle, Leutenbach (DE)

(21) Appl. No.: 19/128,635

(22) PCT Filed: Nov. 20, 2023
(86) PCT No.: PCT/EP2023/082409

§ 371 Date: May 9, 2025

(30) Foreign Application Priority Data
Nov. 28, 2022 (DE) 10 2022 212 694.7

(51) Int. Cl. B41J 25/308; B41J 2/14; B41J 2/155; B41J 2/16; B41J 2/175; B41J 25/312

(52) U.S. Cl. CPC B41J 25/308; B41J 2/14; B41J 2/155; B41J 2/1642; B41J 2/17509; B41J 2/17513; B41J 25/312; B41J 2202/20

(57) ABSTRACT

The invention relates to a printhead (1) for a 3D printer (50) for producing an object (6), said printhead comprising a reservoir (2) for holding a liquid phase (32) of a starting material (3) of variable viscosity, means (4) being provided for varying the pressure in the reservoir (2) and the reservoir (2) having at least one outlet opening (5) from which the liquid phase (32) of the starting material (3) can be expelled by increasing the pressure in the reservoir (2) in order to produce the object (6), a pressure measuring system (100) for measuring the pressure of the liquid phase (32) being located in the region (5a) of the outlet opening (5), and the pressure measuring system (100) comprising an adapter device (110), a connecting element (120), a pressure sensor (130), and a liquid medium (140) for transmitting pressure within the pressure measuring system (100).

The invention also relates to a 3D printer (50) comprising a printhead (1).

### BACKGROUND

A 3D printer for a material that varies in viscosity receives a solid phase of said material as the starting material, generates a liquid phase therefrom, and selectively brings this liquid phase to the points associated with the object to be produced. Such a 3D printer comprises a printhead, in which the starting material is made ready for printing. Furthermore, means are provided for generating a relative movement between the printhead and the work surface on which the object is to be created. Either only the printhead, only the work surface or both the printhead and the work surface can be moved.

Typically, the liquid phase of the starting material is expelled from an outlet opening by the application of a force or pressure, so that it attaches itself to the object to be produced and solidifies there. The liquid phase of the starting material can optionally emerge from the outlet opening as a continuous strand or in the form of individual droplets. When the diameter of the outlet opening is fixed, the most important control variable during the printing process is the force applied to the liquid phase, or the pressure applied to this liquid phase. US 2016/046 073 A1 discloses that the pressure, among other things, can be used to adjust the shear force exerted by the outlet opening on the liquid phase, as well as the viscosity of the liquid phase.

DE 10 2016 222 306 A1 discloses a printhead for a 3D printer with a conveying device for conveying granules from a feed zone into a plasticizing zone, wherein the conveying device comprises a piston that can be introduced into the feed zone.

DE 10 2016 222 315 A1 discloses a printhead for a 3D printer, wherein a pressure sensor for the pressure and a temperature sensor for the temperature of the liquid phase of the starting material are arranged in the region of the outlet opening.

### SUMMARY

The purpose of the invention is to provide a printhead that enables a stable printing process at low cost.

The invention relates to a printhead for a 3D printer for producing an object and to a 3D printer with a printhead according to the invention.

In the context of the invention, a printhead for a 3D printer was developed. This printhead contains a reservoir for holding a liquid phase of a variable-viscosity starting material. Means are provided for changing the pressure p in the reservoir. The reservoir has at least one outlet opening through which the liquid phase of the starting material can be expelled towards the object to be produced by increasing the pressure in the reservoir. A pressure measurement system for measuring the pressure of the liquid phase is arranged in the region of the outlet opening.

According to the invention, the pressure measurement system comprises an adapter device, a connecting element, a pressure sensor and a liquid medium for transmitting pressure within the pressure measurement system.

It has been recognized that pressure is the primary parameter that determines the mass flow of the starting material out of the outlet opening. The value of the pressure at the outlet opening is decisive here. The pressure at the outlet opening can be significantly different from the pressure introduced at the other end of the reservoir into the liquid phase of the starting material, for example. Most of the materials used in 3D printers are thermoplastic and therefore compressible. For example, if the diameter of the outlet opening is in the order of 100 μm, so that structures with an accuracy of +50 μm can be printed, high pressures of around 1500 bar are required to drive the starting material through the outlet opening. At pressures of this magnitude, the compressibility of the starting material is relevant to such an extent that determining the mass flow rate based on a pressure applied to the starting material far from the outlet opening is inaccurate.

Even if the pressure is no longer evaluated in terms of the mass flow in the simplest design, its measurement or monitoring already enables quality control. If, for example, the pressure has remained constant within certain limits during the printing process, this can be taken as a sign that the printing process is of comparatively high quality. Strong fluctuations in pressure, on the other hand, can be interpreted as a signal that problems have occurred during the printing process. This means that the produced object can be marked as scrap, for example. If the quality falls below a certain minimum, the printing process can also be aborted in order to avoid investing any more time or starting material in a product that can no longer be saved.

This is particularly important when using 3D printing in industrial production, where a quality assurance strategy is usually mandatory for a production process to be certified.

The design of the pressure measurement system according to the invention favorably allows for a flexible and modular design, so that the size of the printhead can be reduced. The modular design of the pressure measurement system favorably reduces the cost of melt pressure measurement by eliminating the need for a high temperature pressure sensor built directly into the reservoir. The system is therefore an advantageous, economical and technologically sound solution that can be used at high temperatures.

The decision not to install the pressure sensor directly on the printhead is advantageous in that it helps to reduce the weight and size of the printhead, since neither the sensor nor additional evaluation electronics need to be located close to the printhead.

Furthermore, the design according to the invention makes it possible that the necessary evaluation electronics no longer have to be located near the hot measuring zone, which leads to better measurement results, since the temperature influence on the measurement is reduced.

In a further training course, the adapter device is arranged on the reservoir of the printhead.

In a preferred training, the adapter device has a membrane in the direction of the reservoir and a cavity between the membrane and the connecting element for holding the medium. This is advantageous for achieving pressure transmission between the membrane and the pressure sensor.

The use of a membrane in the adapter device to absorb the pressure in the reservoir allows for a robust design and thus offers advantages over, for example, optical fibers or piezoresistive elements. The membrane, in particular the pressure membrane, is made of spring steel in a particularly favorable design.

The connecting element, which is arranged between the adapter device heated by the melt and the possibly temperature-sensitive pressure sensor, advantageously fulfills the function of passively dissipating heat from the medium and releasing it into the environment so that the pressure sensor does not overheat. Thus, the connecting element provides passive cooling of the medium in an advantageous way.

The cavity created by the adapter device and the connecting element is filled with a medium, such as oil, that can be used at temperatures of up to 380° C. or higher. In a particularly favorable embodiment, the medium is a cylinder oil with an operating temperature of about 380° C. The printhead has a constant temperature behavior during operation with respect to the melt preparation, whereby the viscosity of the medium for absorbing the pressure during printing operation remains constant.

In another embodiment, the medium can be a metal with a low melting point.

In a further training, the adapter device is formed in several parts, comprising at least a core comprising the cavity for holding the medium and an adapter for fastening the adapter device to the reservoir.

In a further training course, a gap is formed between the core and the adapter of the adapter device and the adapter has a venting means for venting the gap.

The venting means, in particular the venting screw, can be used to advantage when filling and changing the medium to flush out the air present in the cavity.

In a training program, the pressure sensor is connected to the connecting element via a holding device.

Thanks to the modular design, the pressure sensor is far enough away from the heated melt that standard sensors can be used. In an advantageous embodiment, the pressure measurement sensor has an operating temperature of about 130° C.

In a further training course, the holding device has a calibration device for adjusting the pressure of the medium in the pressure measurement system.

In a further training course, the calibration device has an adjustable piston.

A temperature sensor can be used in further training that measures the temperature of the medium.

Furthermore, a control system can be used in a further training course, which has the task of recording all process parameters during operation in order to control the pressure measurement system so that the measurement results are not affected. Possible influencing factors would be the temperature expansion of the medium, an excessive primary pressure in the measuring system and the presence of residual air in the system.

Furthermore, the invention comprises a 3D printer with a printhead according to the invention.

### BRIEF DESCRIPTION OF THE DRAWINGS

Further measures for improving the invention are described in greater detail hereinafter, together with the description of the preferred exemplary embodiments of the invention, with reference to the figures.

Exemplary embodiments Shown are:

FIG. 1 a printhead (1) of a 3D printer (50) according to the prior art;

FIG. 2 a printhead (1) with a pressure measurement system (100) according to the invention and

FIG. 3 a section of the pressure measurement system (100).

### DETAILED DESCRIPTION

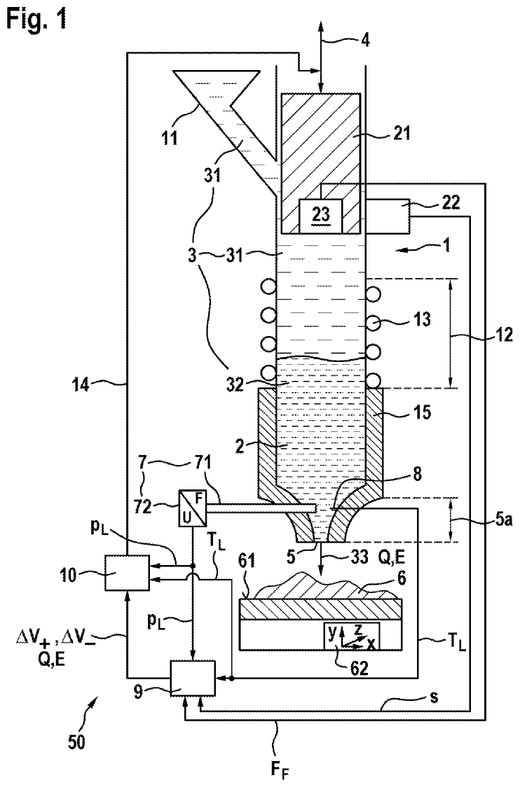

FIG. 1 shows a state-of-the-art 3D printer 50 that has a piston extruder with a movable piston 21. A solid phase 31 of a starting material 3 is present as a granulate that is fed via a feed hopper 11. When the piston 21 in the printhead 1 is retracted or moved upwards, solid starting material 31 trickles out of the feed hopper 11. When the piston 21 is then pushed forward or down, the solid starting material 31 is pressed into the plasticizing zone 12, which is equipped with a heater 13. In the plasticizing zone 12, the liquid phase 32 of the starting material 3 is formed.

A reservoir 2 runs in the region 5a of an outlet opening 5 in a nozzle-like manner. The material 33 passing through the outlet opening is discharged in the direction of an object 6 to be produced, which is being constructed on a base plate 61 that can be moved in this example in the three spatial directions x, y and z by means of a positioning unit 62. Also known are positioning units 62 below the printhead 1, which can only be moved in the z-direction, in which case the printhead moves in the x-y direction. The discharged material 33 transports a mass flow Q and an energy flow E.

A pressure sensor 7 for the pressure p_{L} and a temperature sensor 8 for the temperature T_{L} of the liquid phase 32 of the starting material 3 are arranged in region 5a of the outlet opening 5. The pressure sensor 7 consists of a plunger 71 guided through the thermal insulation 15 into the reservoir 2 and a force sensor 72 on which the plunger 71 acts. The measured pressure p_{L} and the measured temperature T_{L} are transmitted to an evaluation unit 9.

The evaluation unit 9 calculates the volume increase ΔV₊, the volume shrinkage ΔV₋, the mass flow Q and the energy flow E.

The pressure p in reservoir 2 is generated by the advance of piston 21. The piston 21 is therefore driven by a means 4 for generating the pressure p in the reservoir 2.

In addition, this example also comprises a displacement measuring system 22 for the position s of the piston 21 in the printhead 1 and a force sensor 23 for the force F_{F} exerted by the piston 21. In addition to the pressure p_{L} and the temperature T_{L} of the liquid phase 32 of the starting material 3, the evaluation unit 9 also receives the position s and the force F_{F}. p_{L} and T_{L} are also passed directly to a controller 10, which acts on the drive source 4 of the piston 21 with a control variable 14. This enables controller 10 to control p_{L} and/or T_{L} to a specified setpoint.

Furthermore, the controller 10 also receives the variables ΔV₊, ΔV₋, Q and E determined by the evaluation unit 9. The controller 10 is thus also able to control one or more of these variables to a predetermined setpoint.

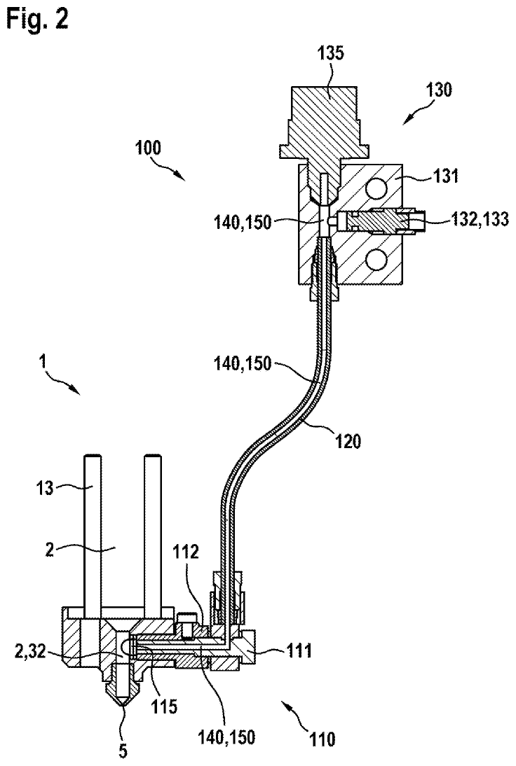

FIG. 2 shows a printhead 1 according to the invention for a 3D printer 50 for producing an object 6, the basic structure of the printhead 1 being described in FIG. 1. A pressure measurement system 100 for measuring the pressure p_{L} of the liquid phase 32 is arranged in the region of the outlet opening 5. The liquid phase 32 is the melt and the pressure the melt pressure. The pressure measurement system 100 comprises an adapter device 110, a connecting element 120, a pressure sensor 130 and a liquid medium 140 for transmitting pressure within the pressure measurement system 100.

The adapter device 110 is located on the reservoir 2 of the printhead 1. The reservoir 2 forms a nozzle antechamber of the printhead 1. The adapter device 110 has a membrane 115 pointing towards reservoir 2 and a cavity 150 between the membrane 115 and the connecting element 120 for holding the medium 140.

The adapter device 110 is formed in several parts, with these comprising at least one core 111, encompassing the cavity 150 for holding the medium 140, and an adapter 112 for fastening the adapter device 110 to the reservoir 2.

A sensor assembly 130 is arranged on the part of the connecting element 120 opposite the adapter device 110, wherein the pressure sensor 135 is connected to the connecting element 120 via a holding device 131 on said sensor assembly.

The holding device 131 has a calibration device 132 for adjusting a pressure of the medium 140 in the pressure measurement system 100.

The calibration device 132 has an adjustable piston 133.

The pressure measuring system 100 arranged on the printhead 1 fulfills the function of measuring the melt pressure of the melt 32 present in the reservoir 2 or melt reservoir and in the nozzle antechamber. In this case, there is a membrane 115 on the wall of reservoir 2, which closes reservoir 2. On the other side of the membrane 115 is the cavity 150, which extends from the core 111 of the adapter device 110 via the connecting element 120 into the sensor assembly 130. In this exemplary embodiment, the core 111 of the adapter device is formed from a hollow screw that is inserted or screwed into the adapter 112. The hollow screw 111 is thus connected to the pressure sensor 135 by the connecting element 120 or the connecting tube. The cavity 150 created by the hollow screw 111 and the connecting tube 120 is filled with the medium 150.

If the melt pressure in the region of the melt reservoir 2 changes, the membrane 115 deforms elastically relative to the pressure. In this way, the pressure change is transmitted from the membrane 115 to the medium 140 in the cavity 150 and thus the pressure change is detected by the pressure sensor 135.

To calibrate the pressure measurement system 100, a calibration piston 133 is attached to the holding device 131 of the sensor assembly 130, which is connected to the cavity 150. This allows a pre-set pressure to be set in the pressure measurement system 100.

Furthermore, the connecting element 120 has the function of passively dissipating heat from the medium 140 and releasing it into the environment so that the pressure sensor 135 does not overheat. Thus, the connecting element provides passive cooling of the medium 140.

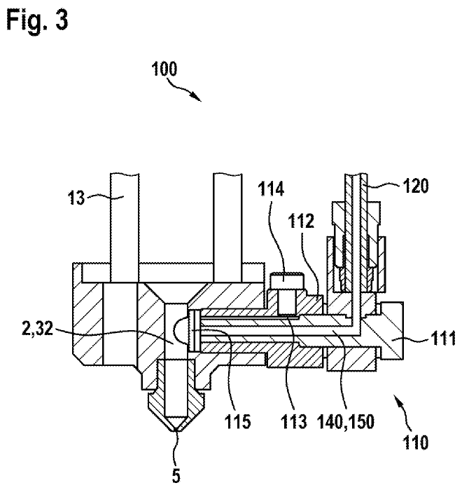

FIG. 3 shows in detail that a gap 113 is formed between the core 111 and the adapter 112 of the adapter device 110 and that the adapter 112 has a venting means 114 for venting the gap 113.

The gap 113 formed between the adapter 112 and the hollow screw 111 extends in the axial direction of the hollow screw 111 up to the membrane 115 and is closed to the outside by the venting means 114 or the venting screw. The air in the cavity 150 can be flushed out through the venting screw 114 when filling and changing the medium 140.

1. A printhead (1) for a 3D printer (50) for producing an object (6), said printhead comprising a reservoir (2) for holding a liquid phase (32) of a starting material (3) of variable viscosity, means (4) for varying a pressure in the reservoir (2), and the reservoir (2) having at least one outlet opening (5) from which the liquid phase (32) of the starting material (3) can be expelled by increasing the pressure in the reservoir (2) in order to produce the object (6), wherein a pressure measuring system (100) for measuring the pressure of the liquid phase (32) is arranged in a region (5a) of the outlet opening (5) wherein the pressure measuring system (100) comprises an adapter device (110), a connecting element (120), a pressure sensor (130), and a liquid medium (140) for transmitting pressure within the pressure measuring system (100).

2. The printhead (1) according to claim 1, wherein the adapter device (110) is arranged on the reservoir (2) of the printhead (1).

3. The printhead (1) according to claim 2, wherein the adapter device (110) has a membrane (115) in a direction of the reservoir (2) and a cavity (150) for holding the medium (140) between the membrane (115) and the connecting element (120).

4. The printhead (1) according to claim 3, wherein the adapter device (110) is formed in several parts, comprising at least a core (111) enclosing the cavity (150) for holding the medium (140) and an adapter (112) for fastening the adapter device (110) to the reservoir (2).

5. The printhead (1) according to claim 4, wherein gap (113) is formed between the core (111) and the adapter (112) of the adapter device (110), and the adapter (112) has a venting means (114) for venting the gap (113).

6. The printhead (1) according to claim 1, wherein the pressure sensor (135) is connected to the connecting element (120) via a holding device (131).

7. The printhead (1) according to claim 6, wherein the holding device (131) comprises a calibrating device (132) for adjusting a pressure of the medium (140) in the pressure measuring system (100).

8. The printhead (1) according to claim 6, wherein the calibration device (132) has an adjustable piston (133).

9. A 3D printer (50) with a printhead (1) according to claim 1.
